(19) United States
(12) Patent Application Publication
(10) Pub. No.: US 2009/0037632 A1
(43) Pub. Date: Feb. 5, 2009

(54) RECHARGEABLE WIRELESS PORTABLE DEVICE

(76) Inventor: Bart M. DOWNING, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/830,678

(22) Filed: Jul. 30, 2007

(51) Int. Cl. G06F 13/00; H02J 7/00

(52) U.S. Cl. 710/300; 320/103; 320/114

(57) ABSTRACT

A portable device comprises a wireless transceiver adapted to wirelessly communicate with a computing device. The portable device comprises a battery that provides power to the wireless transceiver. The portable device also comprises a first connector adapted to mate with a corresponding second connector on the computing device. The battery receives charging current from the portable computing device via the first connector.

### BACKGROUND

Portable computing devices such as notebook computers generally comprise a network interface controller (NIC) to which a network cable can be connected. Through the NIC and network cable, the notebook computer is provided with network connectivity. Because the network cable connects to the notebook computer, the network cable limits where the notebook computer can be used. The portability afforded by the notebook computer is therefore hampered by the network cable. For example, if the user is in a hotel room, the user's notebook computer may have to be used at the desk provided in the hotel room because the desk it typically the location at which the hotel owner provides a network cable. The user, in such as situation, would be hard-pressed to use the notebook computer elsewhere in the hotel room (e.g., in bed).

### BRIEF DESCRIPTION OF THE DRAWINGS

For a detailed description of exemplary embodiments of the invention, reference will now be made to the accompanying drawings in which:

FIG. 1 illustrates a notebook computer into which a battery-operated, wireless access point can be inserted for charging in accordance with various embodiments;

FIG. 2 shows a slot in the notebook computer's housing for receiving the battery-operated, wireless access point in accordance with various embodiments;

FIG. 3 shows illustrates a layout schematic of the battery-operated, wireless access point in accordance with various embodiments;

FIG. 4 illustrates a block diagram of the battery-operated, wireless access point in accordance with various embodiments; and

FIG. 5 illustrates a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

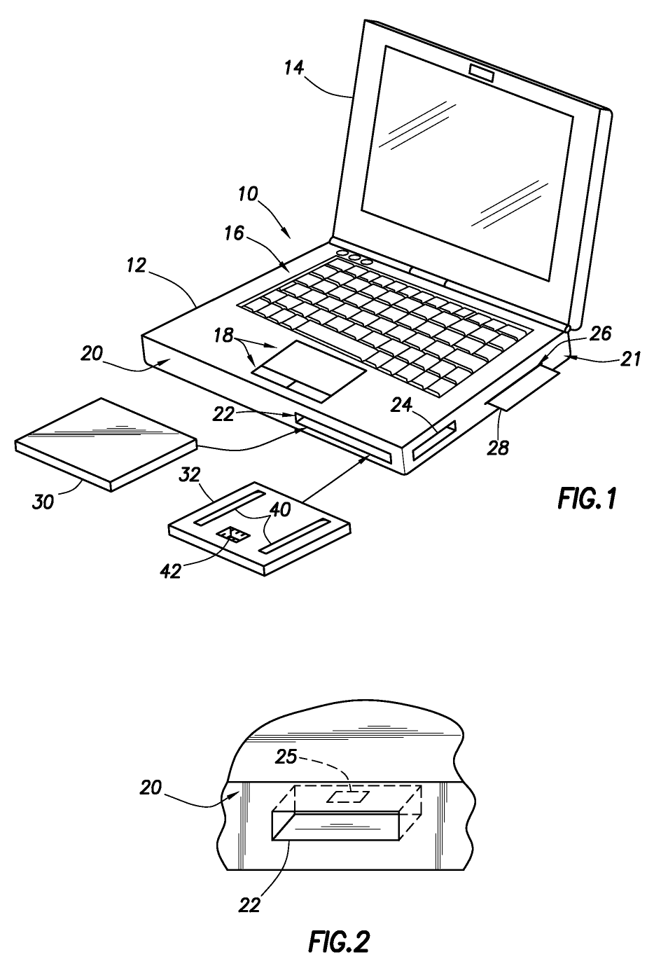

Referring to FIG. 1, a system 10 is shown in accordance with various embodiments. The system 10 comprises a portable computing device such as notebook computer, and may be referred to herein as a notebook computer. In other embodiments, the portable computing device 10 may be other than a notebook computer. As shown in FIG. 1, notebook computer 10 comprises a chassis 12 which comprises the computer's processor, memory, and other components. A display 14 is coupled to the chassis 12 via a hinge that enables the display to be opened and closed. The chassis 12 provides a keyboard 16 and pointing devices 18 (e.g., touchpad) for a user to interact with the notebook computer 10. A side surface 21 of the chassis 12 comprises one or more slots 24 and 26 for receiving circuit cards such as Personal Computer Memory Card International Association (PCMCIA) cards, Peripheral Component Interconnect (PCI) cards, PCI Express Card slots, etc. A circuit card 28 is shown inserted into slot 28 Circuit card 28 comprises a wireless card to enable the notebook computer 10 to access a wireless network.

In accordance with various embodiments, the chassis 12 comprises a front surface 20 which comprises a user-accessible slot 22, although the slot can be provided a surface other than the front surface 20. The slot 22 is adapted to receive a peripheral device 30 or a battery-operated, wireless access point 32. The peripheral device 30 may comprise any of a variety of storage media such as compact disc read only memory (CD ROM) drive. In such embodiments, the slot comprises an optical drive bay. The slot 22 comprises an electrical connector 25 as shown in FIG. 2, as well as mechanical members (e.g., rails) for mechanically receiving the peripheral device 30 or wireless access point 32. The peripheral device 30 and wireless access point 32 both comprise a corresponding connector for mating to the slot's electrical connector 25. Each of the peripheral device 30 and wireless access point 32 has the same or similar size and shape as the size and shape of slot 22. If the user of notebook computer 10 desires to use the peripheral device 30, the user inserts (e.g., slides) peripheral device 30 into slot 22.

The wireless access point 32 is battery-operated in accordance with various embodiments. The battery used in the wireless access point 32 is rechargeable in accordance with various embodiments. Thus, if the user of notebook computer 10 desires to recharge the battery in the wireless access point 32, the user inserts the wireless access point 32 into slot 22. The wireless access point 32 comprises a housing that is adapted to at least partially fit within slot 22.

In the embodiments show in FIG. 1, slot 22 accepts one, but not both, of the peripheral device 30 and wireless access point 32 at any one point of time. Accordingly, if the peripheral device 30 already occupies slot 22 and the user desires to recharge the battery in the wireless access point 32, the user removes the peripheral device 30 from slot 22 and then inserts the access point 32 into slot 22. In some embodiments, the wireless access point 32 does not provide network connectivity to the notebook computer 10 when inserted into slot 32. Instead, in such embodiments, the access point's battery is charged when the access point 32 is in slot 32. To use the access point 32 for network connectivity, the access point 32 is removed from the slot 22 and connected to a network cable as discussed below.

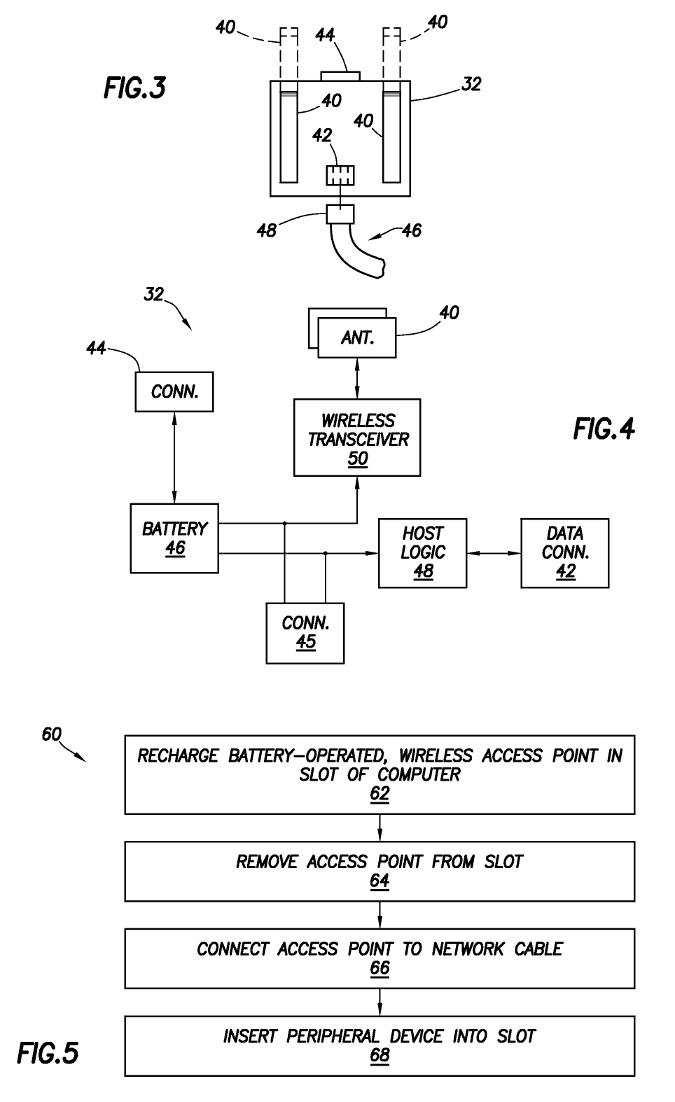

FIG. 3 illustrates a schematic layout of the wireless access point 32 in accordance with at least one embodiment. As shown in FIG. 3, and also in FIG. 1, the wireless access point 32 comprises one or more antennas 40 which are coupled to the housing of the wireless access point 32 by way of hinge mechanisms. As such, each of the antennas 40 can be swung out and deployed to an operating position as shown at by the dashed lines in FIG. 3.

The wireless access point 32 also comprises two electrical connectors 42 and 44 in the embodiments shown in FIG. 3. Electrical connector 42 comprises a data connector to which a connector 48 of a network cable 46 can be coupled. Electrical connector 44 mates with the corresponding electrical connector 25 in slot 22 of the notebook computer 10. In accordance with various embodiments, the electrical connector 25 comprises power and data signals for operating the peripheral device 30. When the wireless access point 32, however, is inserted into slot 22, only power is provided from electrical connector 25 to the wireless access point via electrical connector 44 for charging the wireless access point's battery. In accordance with such embodiments, the electrical connector 44 of the wireless access point 32 may be of the same size and type as the electrical connector of the peripheral device 30 that mates with connector 25 in slot 22. However, internal circuitry in the wireless access point electrically couples only to the power signals of electrical connector 25 and not to the data signals of electrical connector 25. Thus, the electrical connector 44 of the wireless access point mechanically couples to both power and data pins in the electrical connector 25 of the slot 22, but electrically couples only to the power pins of connector 25 and not the data pins. In such embodiments, no data connectivity is established between notebook computer 10 and wireless access point 32 when the wireless access point 32 is installed in slot 22. In other embodiments, however, data connectivity may be established between the electrical connector 25 of slot 22 and the electrical connector 44 of the wireless access point 32.

FIG. 4 shows an illustrative block diagram of the wireless access point 32. As shown in FIG. 4, the wireless access point 32 comprises antennas 40 and connectors 42 and 44 as discussed above. The wireless access point 32 also comprises a battery 46, host logic 48 and a wireless transceiver 50. The battery 46 is rechargeable in accordance with various embodiments. In other embodiments, the battery 46 may be removable and not rechargeable. The battery 46 receives charging current from the notebook computer 10 via electrical connector 44. Electrical power from the battery 46 is provided to the wireless transceiver 50 and host logic 48. In some embodiments, a connector 45 for receiving direct current (DC) power from an alternating current (AC)-connected adapter may be provided. Thus, the access point 32 may be powered by a battery 46 and/or by externally-provided power.

The host logic 48 comprises the main operating logic of the wireless access point 32. The host logic 48 couples to the wireless transceiver 50. The host logic 48 receives communications from the antennas 40 and/or provides communications to the antennas 40. The wireless transceiver 50 comprises a radio frequency (RF) transceiver in accordance with various embodiments. In accordance with various embodiments, the wireless access point 32 complies with any of the IEEE 802.11 family of wireless protocols.

FIG. 5 illustrates a method 60 in accordance with various embodiments. At 62, method 60 comprises recharging the battery-operated wireless access point in slot 22 of the notebook computer 10. The action can be performed by, for example, a user inserting the wireless access point 32 into the slot 22 of the notebook computer 10. When the notebook computer 10 is powered on, the wireless access point 32 will receive charging current from the power supply of the notebook computer 10. In other embodiments, the notebook computer 10 need not be booted up to charge the battery 46 in the wireless access point 32. Instead, an auxiliary power feed from the notebook computer's power supply can be provided to the electrical connector 25 of slot 22. As long as the notebook computer 10 is connected to a source of alternating current (AC) power, the battery 46 in the wireless access point 32 can be charged while in slot 22 regardless of whether the notebook computer 10 has been booted.

At 64, method 60 comprises removing the wireless access point 32 from slot 22. At 66, the data connector 42 of the wireless access point 32 and the connector 48 of the network cable 46 are connected together to connect the access point 32 to the network cable 46. As shown in FIG. 1, the notebook computer 10 comprises its own wireless transceiver 26 (wireless card). The wireless transceiver 26 of the notebook computer 10 and the wireless access point 32 connected to network cable 46 wirelessly communicate with each other in this way the notebook computer 10 is provided with network access. If desired, the user can insert peripheral device 30 into the vacant slot 22 and thus use peripheral device 30 as desired.

FIG. 1 illustrates two different embodiments in which a slot can receive the wireless access point 32 for at least charging the access point's battery. The slot 22 may comprise an optical drive bay in some embodiments. Additionally, or alternatively, a slot 24, 26 can be provided. In the embodiment of FIG. 1, slot 24 comprises a PCMCIA card slot or an Express Card or PCI card slot. The access point's size and shape will be in accordance with the particular slot used to charge the access point's battery.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A portable device, comprising:
a wireless transceiver adapted to wirelessly communicate with a computing device; and
a battery that provides power to the wireless transceiver;
a first connector adapted to mate with a corresponding second connector on said portable computing device, and said battery receives charging current from said computing device via said first connector.

2. The portable device of claim 1 further comprising a housing containing at least said wireless transceiver, said housing adapted to at least partially fit within a corresponding slot in said portable computing device when said battery is being charged.

3. The portable device of claim 2 wherein the slot comprises a bay for an optical drive.

4. The portable device of claim 2 wherein the slot comprises a slot for a circuit card.

5. The portable device of claim 1 further comprising a data connector.

6. The portable device of claim 6 wherein said data connector receives a connector from a network cable.

7. The portable device of claim 1 wherein said portable device comprises a wireless access point.

8. The portable device of claim 1 wherein said first connector mechanically couples to power and data pins in said second connector, said first connector electrically coupling to said power pins but not said data pins.

9. A system, comprising:
a first wireless transceiver; and
a slot adapted to selectively receive a peripheral device and a second wireless transceiver, said second wireless transceiver being battery-powered and, when removed from said slot, adapted to wirelessly communicate with said first wireless transceiver to provide network connectivity to said system.

10. The system of claim 9 wherein said slot comprises a slot adapted to receive an optical drive.

11. The system of claim 9 wherein said slot comprises a slot adapted to receive a circuit card.

12. The system of claim 9 said slot comprises power and data signals and said second wireless transceiver electrically couples to said power signals and not to said data signals.

13. The system of claim 9 wherein said first and second wireless transceivers are IEEE 802.11-compliant.

14. The system of claim 9 wherein said slot comprises a connector comprising a power and pins and said second wireless transceiver electrically coupled to said power pins but not said data pins.

15. The system of claim 9 wherein said second wireless transceiver comprises a network connector adapted to be coupled to a network cable to provide wireless network connectivity to the first wireless transceiver, and when said first and second wireless transceivers wirelessly communicate with each other, said slot receives said peripheral device.

16. The system of claim 9 wherein said system comprises a portable computer.

17. A method, comprising:
recharging a battery-operated, wireless access point in a slot of a computer;
removing said wireless access point from said slot; and
connecting said wireless access point to a network cable.

18. The method of claim 17 further comprising inserting said wireless access point in said slot to recharge said wireless access point.

19. The method of claim 17 further comprising establishing wireless communications between said wireless access point and a wireless transceiver in said computer.

20. The method of claim 17 further inserting a peripheral device in said slot after removing said wireless access point from said slot.
